(19) United States
(12) Patent Application Publication
(10) Pub. No.: US 2017/0053576 A1
(43) Pub. Date: Feb. 23, 2017

(54) INFORMATION PROCESSING METHOD AND APPARATUS

(71) Applicant: Beijing Zhigu Rui Tuo Tech Co., Ltd, Beijing (CN)

(72) Inventors: Liang ZHOU, Beijing (CN); Hongjiang ZHANG, Beijing (CN)

(21) Appl. No.: 15/307,367

(22) PCT Filed: Apr. 16, 2015
(86) PCT No.: PCT/CN2015/076711

§ 371 Date: Oct. 27, 2016

(30) Foreign Application Priority Data
Apr. 28, 2014 (CN) 201410174385.3

(51) Int. Cl. G09G 3/00; G06Q 10/10; G06K 9/20; G09G 5/14; G06F 3/01

(52) U.S. Cl. CPC G09G 3/002; G09G 5/14; G06F 3/013; G06K 9/2081; G06Q 10/10; G09G 2354/00

(57) ABSTRACT

Embodiments of the present application provide an information processing method and apparatus. The method comprises: displaying a window, wherein the window comprising at least one area, and the at least one area respectively corresponds to one information processing manner; determining that an information carrier overlaps with at least one area in the at least one area; and processing, according to at least one information processing manner corresponding to the at least one area that the information carrier overlaps with, information carried by the information carrier. The embodiments of the present application provide an information processing solution, to enable a user to quickly and conveniently select an information processing manner.

### RELATED APPLICATION

The present international patent cooperative treaty (PCT) application claims the benefit of priority to Chinese Patent Application No. 201410174385.3, filed on Apr. 28, 2014, and entitled “Information Processing Method and Apparatus”, which is hereby incorporated into the present international PCT application by reference herein in its entirety.

### TECHNICAL FIELD

Embodiments of the present application relate to the field of information technologies, and in particular, to an information processing method and apparatus.

### BACKGROUND

In some occasions, people rapidly process some information. For example, in social occasions, people may establish relationships by exchanging business cards, and generally, received business cards are further classified according to certain categories, for example, information of a received business card is added to address books or one person sends his/her own business card to the other person who he/she received a business card from, and the like.

### SUMMARY

In view of this, an example objective of embodiments of the present application is to provide an information processing solution.

To achieve the foregoing example objective, according to one aspect of the embodiments of the present application, an information processing method is provided, comprising:

displaying a window, wherein the window comprises at least one area, and the at least one area respectively corresponds to one information processing manner;

determining that an information carrier overlaps with at least one area in the at least one area; and

processing, according to at least one information processing manner corresponding to the at least one area that the information carrier overlaps with, information carried by the information carrier.

To achieve the foregoing example objective, according to another aspect of the embodiments of the present application, an information processing apparatus is provided, comprising:

a display module, configured to display a window, wherein the window comprises at least one area, and the at least one area respectively corresponds to one information processing manner;

an overlapping determining module, configured to determine that an information carrier overlaps with at least one area in the at least one area; and

a processing module, configured to process, according to at least one information processing manner corresponding to the at least one area that the information carrier overlaps with, information carried by the information carrier.

At least one of the foregoing technical solutions has the following example beneficial effects:

In an embodiment of the present application, a window comprising at least one area is displayed, it is determined that an information carrier overlaps with at least one area in the at least one area, and information carried by the information carrier is processed according to at least one information processing manner corresponding to the at least one area that the information carrier overlaps with, so as to provide an information processing solution, to enable a user to quickly and conveniently select an information processing manner.

### BRIEF DESCRIPTION OF THE DRAWINGS

FIG. 1a is an example schematic flowchart of an embodiment of an information processing method according to the present application;

FIG. 1b and FIG. 1c respectively are example schematic diagrams of an overlapping manner according to an embodiment of the present application;

FIG. 2a to FIG. 2e respectively are example schematic diagrams of an overlapping scenario according to an embodiment of the present application;

FIG. 3 is an example schematic diagram of an application scenario according to an embodiment of the present application;

FIG. 4a is an example schematic structural diagram of a first embodiment of an information processing apparatus according to the present application;

FIG. 4b is an example schematic structural diagram of the embodiment shown in FIG. 4a; and

FIG. 5 is an example schematic structural diagram of a second embodiment of an information processing apparatus according to the present application.

### DETAILED DESCRIPTION

The following further describes example embodiments of the present application in detail with reference to the accompanying drawings and embodiments. The following embodiments are used to describe the present application, but not to limit the scope of the present application.

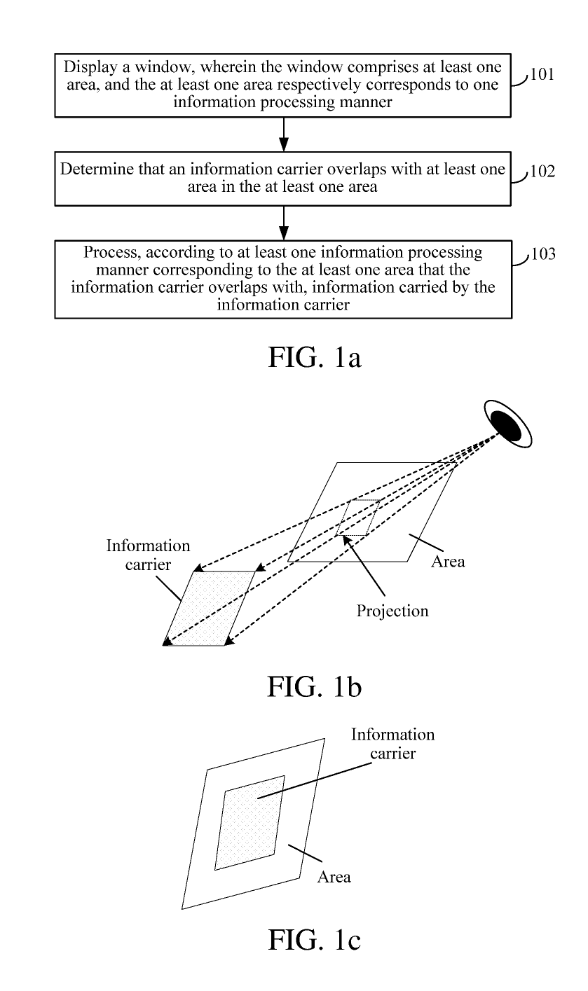

FIG. 1a is a schematic flowchart of an embodiment of an information processing method according to the present application. As shown in FIG. 1a, this embodiment comprises:

101. Display a window, wherein the window comprises at least one area, and the at least one area respectively corresponds to one information processing manner.

For example, an information processing apparatus provided in the present application is used as an execution body of this embodiment, to perform 101-103. Specifically, the information processing apparatus may be disposed in a user equipment in a manner of software, hardware, or a combination of software and hardware, or the information processing apparatus itself is a user equipment; the user equipment comprises, but is not limited to: a smart phone, smart glasses, and a smart helmet, wherein the smart glasses comprise smart frame glasses and smart contact lenses.

Specifically, the at least one area may be arranged in the window in any manner, regularly or irregularly. When the window comprises a plurality of areas, optionally, the plurality of areas completely do not overlap with each other, or partially overlap with each other.

Optionally, different areas correspond to different information processing manners.

In one optional embodiment, the displaying a window comprises:

acquiring a gaze point of a user; and

displaying the window at the gaze point.

In another optional embodiment, the displaying a window comprises:

displaying the window at a position with a preset distance in front of at least one eye of a user.

The preset distance may be a distance suitable for viewing and interaction of the user, for example, 50 cm.

In either one of the foregoing example embodiments, optionally, the information processing apparatus may complete the displaying through a built-in near-eye display or by invoking an external near-eye display. Optionally, the displaying in this embodiment is transmissive displaying, that is, the user can see, through displayed content, an object around the content, such as, the information carrier.

102. Determine that an information carrier overlaps with at least one area in the at least one area.

Specifically, the information carrier in this embodiment may be any object carrying information, and comprises, but is not limited to, any one of the following: a business card, a picture, a label, a two-dimensional code, and a terminal interface. For example, when the business card is used as the information carrier, carried information may comprise a name, a service agency, a position, contact information and the like of the owner of the business card; when the picture is used as the information carrier, carried information may comprise content shown by the picture, and information embedded into the content, such as a watermark; when the label is used as the information carrier, carried information may comprise information about an object that the label is directed to, such as a name, a model, a price and the like of a commodity; when the two-dimensional code is used as the information carrier, carried information may comprise information recorded by the two-dimensional code, such as a website, a business card, text information, and a specific code; and when the terminal interface is used as the information carrier, carried information may comprise content displayed on the interface.

The overlapping between the information carrier and the area may be overlapping in a direction of a sight line of the user, as shown in FIG. 1b, when the user looks at the information carrier, projection of the information carrier in a plane of the area is within the range of the area; or, the overlapping may be overlapping in a spatial position, as shown in FIG. 1c, the information carrier and the area are in one plane, and the information carrier is within the range of the area.

In one optional embodiment, in order to help the user to select an appropriate information processing manner, the information processing manner may be prompted to the user. Optionally, one corresponding information processing manner is respectively displayed in the at least one area comprised in the window displayed in 101, or, after 102, at least one information processing manner corresponding to the at least one area that the information carrier overlaps with is prompted to the user. There are many prompting manners, comprising, but not limited to: auditory prompts and visual prompts. Optionally, the prompting the user at least one information processing manner corresponding to the at least one area that the information carrier overlaps with comprises: respectively displaying, in the at least one area, the at least one information processing manner corresponding to the at least one area that the information carrier overlaps with.

103. Process, according to at least one information processing manner corresponding to the at least one area that the information carrier overlaps with, information carried by the information carrier.

For example, the window displayed in 101 comprises four areas A to D, wherein the four areas A to D respectively correspond to information processing manners 1 to 4. If it is determined in 102 that the information carrier overlaps with the area A, in 103, the information carried by the information carrier is processed according to the information processing manner corresponding to the area A, that is, the information processing manner 1; and if it is determined in 102 that the information carrier overlaps with the areas B and C, in 103, the information carried by the information carrier is processed according to the information processing manners corresponding to the areas B and C, that is, the information processing manner 2 and the information processing manner 3.

In one optional embodiment, the information processing manner corresponding to the at least one area in 101 is related to the information carried by the information carrier, and optionally, before 103, this embodiment further comprises:

determining the information carried by the information carrier;

determining at least one information processing manner corresponding to the information; and

determining a correspondence between the at least one information processing manner corresponding to the information and the at least one area comprised in the window.

Usually, different types of information may correspond to different information processing manners. For example, for the information carried by the business card, such as a name, a service agency, a position, and contact information, there may be information processing manners such as adding the information to an address book, returning his/her own business card, searching for and following the information in social networks; and for the information carried by the two-dimensional code, for example, a website, there may be information processing manners such as opening a webpage and adding the website to favorites.

The correspondence may be one to one, one to more, or more to one, which is not limited in this embodiment. For example, for the information carried by the business card, such as a name, a service agency, a position, and contact information, there may be three information processing manners, for example, adding the information to an address book, returning his/her own business card, searching for and following the information in social networks. One possible scenario is that the window comprises three areas, and the three areas correspond to the three information processing manners in a one-to-one manner, or, each area respectively corresponds to one or more of the three information processing manners. Certainly, it is possible that the window may comprise at least one area that does not correspond to any information processing manner. Optionally, when the information carrier overlaps with the area that does not correspond to any information processing manner, no information processing may be performed on the information carried by the information carrier.

To sum up, in a scenario in which the information carried by the information carrier is different, information processing manners corresponding to the same area may also be different.

In one optional embodiment, considering that a spatial position of the information carrier or the window may change, for example, the information carrier may overlap with different areas in a process in which the user holds and moves the information carrier, in order to avoid incorrect operations, optionally, 102 comprises:

determining that an information carrier always overlaps with at least one area in the at least one area within a preset time period.

The preset time period may be set by the user, for example, set to 2 seconds. In some scenarios, even if the spatial position of the information carrier changes, the area that overlaps with the information carrier may not change. For example, if a range of an area that overlaps with the information carrier is large, even if the spatial position of the information carrier changes, 103 can be performed as long as the information carrier always overlaps with the area within the preset time period.

In one optional embodiment, the processing, according to at least one information processing manner corresponding to the at least one area that the information carrier overlaps with, information carried by the information carrier comprises, but is not limited to, any one of the following:

collecting the information;

collecting the information, and analyzing and storing the information; and

collecting the information, and analyzing and responding to the information.

Specifically, each processing may correspond to one or more information processing manners. For example, collecting the information is one information processing manner, and analyzing and storing the information is another information processing manner; or, collecting the information is one information processing manner, and collecting the information and analyzing and storing the information is another information processing manner.

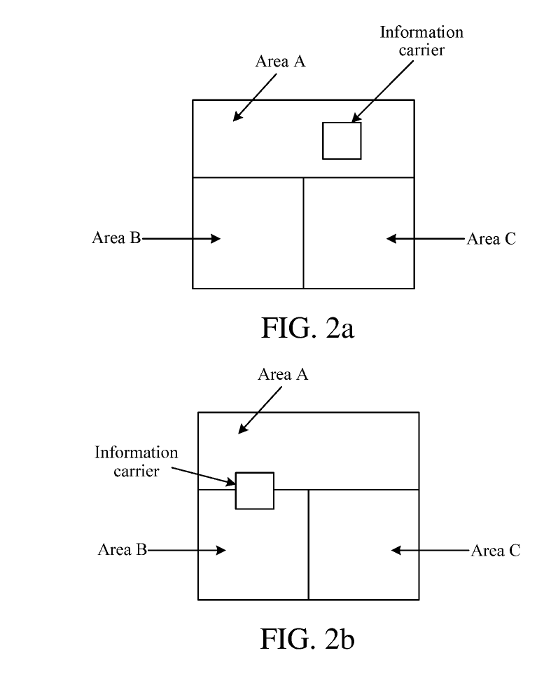

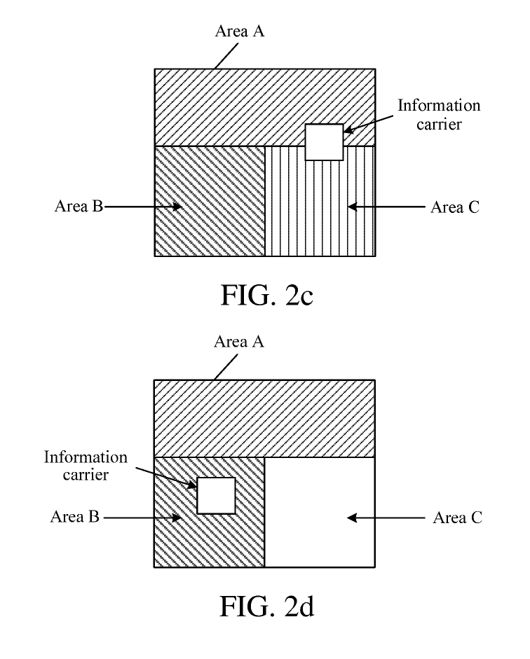

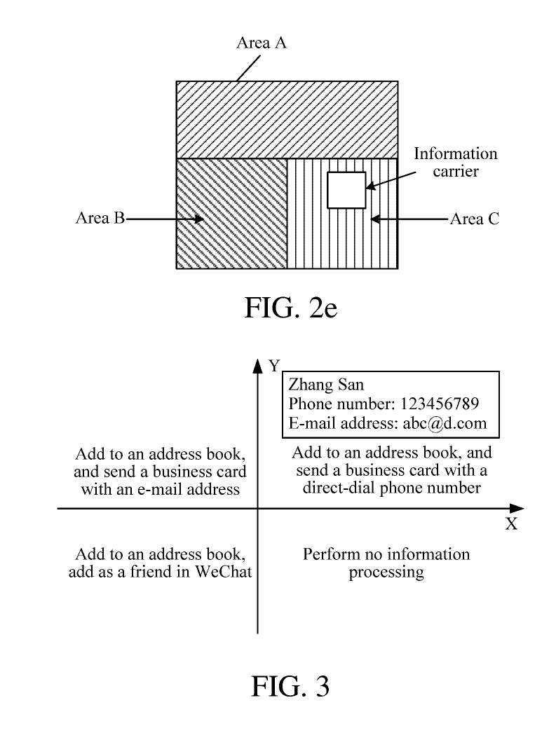

For example, the window displayed in 101 comprises three areas A to C, an information processing manner corresponding to the area A is collecting the information, an information processing manner corresponding to the area B is analyzing and storing the information, and an information processing manner corresponding to the area C is analyzing and responding to the information; therefore, as shown in FIG. 2a, it is determined in 102 that the information carrier merely overlaps with the area A, and the information is collected in 103, or, as shown in FIG. 2b, it is determined in 102 that the information carrier overlaps with the areas A and B, and the information is collected, analyzed, and stored in 103, or, as shown in FIG. 2c, it is determined in 102 that the information carrier overlaps with the areas A and C, and the information is collected, analyzed, and responded to in 103.

For another example, the window displayed in 101 comprises three areas A to C, an information processing manner corresponding to the area A is collecting the information, an information processing manner corresponding to the area B is collecting the information and analyzing and storing the information, and an information processing manner corresponding to the area C is collecting the information and analyzing and responding to the information; therefore, as shown in FIG. 2a, as shown in FIG. 2a, it is determined in 102 that the information carrier merely overlaps with the area A, and the information is collected in 103, or, as shown in FIG. 2d, it is determined in 102 that the information carrier merely overlaps with the area B, and the information is collected, analyzed, and stored in 103, or, as shown in FIG. 2e, it is determined in 102 that the information carrier merely overlaps with the area C, and the information is collected, analyzed, and responded to in 103.

In one optional scenario, the information carrier is a business card; and the processing, according to at least one information processing manner corresponding to the at least one area that the information carrier overlaps with, information carried by the information carrier comprises any one of the following:

collecting an image of the business card;

collecting an image of the business card, and identifying and storing the image;

collecting an image of the business card, identifying and storing the image, and sending information according to an identified communication identifier; and

collecting an image of the business card, identifying and storing the image, and performing a social operation according to an identified user identifier.

Specifically, each processing may correspond to one or more information processing manners. For example, collecting an image of the business card is one information processing manner, and identifying and storing the image is another information processing manner; or, collecting an image of the business card is one information processing manner, and collecting an image of the business card and identifying and storing the image is another information processing manner.

Identifying the image may be identifying the information carried by the business card; the storing may be adding the information carried by the business card to an address book; the communication identifier may be a mobile phone number, an e-mail address or the like, and accordingly, sending information according to an identified communication identifier may be sending information to the mobile phone number through a short message service message or a multimedia messaging service message or sending information to the e-mail address in a form of an e-mail, and the information may specifically be a business card or the like of the user; the user identifier may be a name, a social network user name or the like, and accordingly, performing a social operation according to an identified user identifier may be searching for the name or the social network user name in a social network, and following a searched user or adding a searched user as a friend or the like.

It should be noted that, in the example embodiment of prompting the information processing manner, brief introduction of the information processing manner or a corresponding user category can be prompted. For example, for the information processing manner of “collecting an image of the business card”, “photograph” may be prompted; and for the information processing manner of “collecting an image of the business card, and identifying and storing the image”, “add to an address book” may be prompted. For another example, for the information processing manner of “collecting an image of the business card, and identifying and storing the image”, “persons I may contact” may be prompted; for the information processing manner of “collecting an image of the business card, identifying and storing the image, and sending information according to an identified communication identifier”, “persons I want to know” may be prompted; and for “collecting an image of the business card, identifying and storing the image, and performing a social operation according to an identified user identifier”, “persons with similar interests” may be prompted. The prompts are equivalent to classifications of the business card by the user, which facilitates rapid classification of business cards in social occasions and avoids delaying important dialogues or missing important information that is caused by the fact that the business cards are organized afterwards.

FIG. 3 is a schematic diagram of an application scenario of this embodiment. As shown in FIG. 3, the information carrier is a business card, a two-dimensional coordinate is shown in the window, X and Y axes of the two-dimensional coordinate divide the window into four areas. To facilitate description, an area in which both x and y are greater than 0 are referred to as a first area, an area in which y is greater than 0 and x is less than 0 is referred to as a second area, an area in which both x and y are less than 0 is referred to as a third area, and an area in which x is greater than 0 and y is less than 0 is referred to as a fourth area. The information processing apparatus respectively prompts corresponding information processing manners in the four areas, wherein “add to an address book, send a business card with a direct-dial phone number” is displayed in the first area, “add to an address book, send a business card with an e-mail address” is displayed in the second area, “add to an address book, add as a friend in WeChat” is displayed in the third area, and “perform no information processing” is displayed in the fourth area. When the user wants to select the information processing manner corresponding to the first area according to the prompt, the business card is moved to overlap with the first area (as shown in the figure) and stays for a preset time period, and accordingly, the information processing apparatus performs the information processing manner corresponding to the first area on the information carried by the business card; specifically, the information processing apparatus collects an image of the business card, identifies the image, adds identified information, comprising Zhang San, a phone number being 123456789, and an e-mail address being abc@d.com, to an address book, and sends a business card with a direct-dial phone number of the user to 123456789 through a short message service message or a multimedia messaging service message, or sends the business card to abc@d.com in a form of an e-mail. In this scenario, the user can rapidly and conveniently select a processing manner for the business card without affecting the original activity of the user, for example, social communication with others.

In this embodiment, a window comprising at least one area is displayed, it is determined that an information carrier overlaps with at least one area in the at least one area, and information carried by the information carrier is processed according to at least one information processing manner corresponding to the at least one area that the information carrier overlaps with, so as to provide an information processing solution, to cause that a user can quickly and conveniently select an information processing manner.

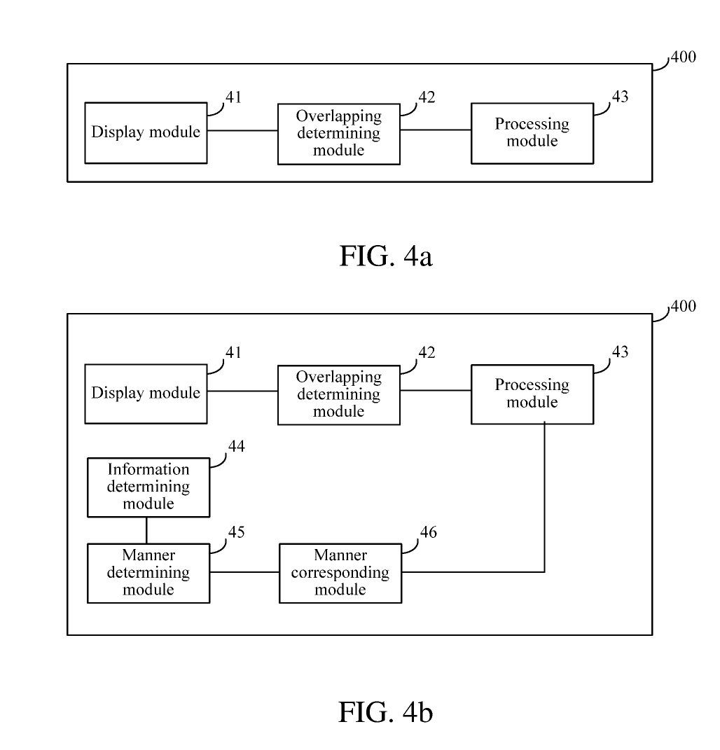

FIG. 4a is a schematic structural diagram of a first embodiment of an information processing apparatus according to the present application. As shown in FIG. 4a, the information processing apparatus 400 (hereinafter briefly referred to as the apparatus 400) comprises:

a display module 41, configured to display a window, wherein the window comprises at least one area, and the at least one area respectively corresponds to one information processing manner;

an overlapping determining module 42, configured to determine that an information carrier overlaps with at least one area in the at least one area; and

a processing module 43, configured to process, according to at least one information processing manner corresponding to the at least one area that the information carrier overlaps with, information carried by the information carrier.

Specifically, the at least one area may be arranged in the window in any manner, regularly or irregularly. When the window comprises a plurality of areas, optionally, the plurality of areas completely do not overlap with each other, or partially overlap with each other.

Optionally, different areas correspond to different information processing manners.

In one optional embodiment, the display module 41 is specifically configured to:

acquire a gaze point of a user; and

display the window at the gaze point.

In another optional embodiment, the display module 41 is specifically configured to:

display the window at a position with a preset distance in front of at least one eye of a user.

The preset distance may be a distance suitable for viewing and interaction of the user, for example, 50 cm.

In either one of the foregoing example embodiments, optionally, the display module 41 may complete the displaying through a built-in near-eye display or by invoking an external near-eye display. Optionally, the displaying in this embodiment is transmissive displaying, that is, the user can see, through displayed content, an object around the content, such as, the information carrier.

Specifically, the information carrier in this embodiment may be any object carrying information, and comprises, but is not limited to, any one of the following: a business card, a picture, a label, a two-dimensional code, and a terminal interface. For example, when the business card is used as the information carrier, carried information may comprise a name, a service agency, a position, contact information and the like of the owner of the business card; when the picture is used as the information carrier, carried information may comprise content shown by the picture, and information embedded into the content, such as a watermark; when the label is used as the information carrier, carried information may comprise information about an object that the label is directed to, such as a name, a model, a price and the like of a commodity; when the two-dimensional code is used as the information carrier, carried information may comprise information recorded by the two-dimensional code, such as a website, a business card, text information, and a specific code; and when the terminal interface is used as the information carrier, carried information may comprise content displayed on the interface.

The overlapping, determined by the overlapping determining module 42, between the information carrier and the area may be overlapping in a direction of a sight line of the user, as shown in FIG. 1b, when the user looks at the information carrier, projection of the information carrier in a plane of the area is within the range of the area, or, the overlapping may be overlapping in a spatial position, as shown in FIG. 1c, the information carrier and the area are in one plane, and the information carrier is within the range of the area.

In one optional embodiment, in order to help the user to select an appropriate information processing manner, the information processing manner may be prompted to the user. Optionally, the display module 41 is further configured to respectively display one corresponding information processing manner in the at least one area, or the apparatus 400 further comprises: a prompting module, configured to: after the overlapping determining module 42 determines that an information carrier overlaps with at least one area in the at least one area, prompt the user at least one information processing manner corresponding to the at least one area that the information carrier overlaps with. There are many prompting manners, comprising, but not limited to: auditory prompts and visual prompts. Optionally, the prompting module is specifically configured to respectively display, in the at least one area, the at least one information processing manner corresponding to the at least one area that the information carrier overlaps with.

For example, the window displayed by the display module 41 comprises four areas A to D, wherein the four areas A to D respectively correspond to information processing manners 1 to 4. If the overlapping determining module 42 determines that the information carrier overlaps with the area A, the processing module 43 processes the information carried by the information carrier according to the information processing manner corresponding to the area A, that is, the information processing manner 1, and if the overlapping determining module 42 determines that the information carrier overlaps with the areas B and C, the processing module 43 processes the information carried by the information carrier according to the information processing manners corresponding to the areas B and C, that is, the information processing manner 2 and the information processing manner 3.

In one optional embodiment, the information processing manner corresponding to the at least one area in the window displayed by the display module 41 is related to the information carried by the information carrier, and optionally, as shown in FIG. 4b, the apparatus 400 further comprises:

an information determining module 44, configured to determine the information carried by the information carrier;

a manner determining module 45, configured to determine at least one information processing manner corresponding to the information; and

a manner corresponding module 46, configured to determine a correspondence between the at least one information processing manner corresponding to the information and the at least one area comprised in the window.

Usually, different types of information may correspond to different information processing manners. For example, for the information carried by the business card, such as a name, a service agency, a position, and contact information, there may be information processing manners such as adding the information to an address book, returning his/her own business card, searching for and following the information in social networks; and for the information carried by the two-dimensional code, for example, a website, there may be information processing manners such as opening a webpage and adding the website to favorites.

The correspondence may be one to one, one to more, or more to one, which is not limited in this embodiment. For example, for the information carried by the business card, such as a name, a service agency, a position, and contact information, the manner determining module 45 may determine that there are three corresponding information processing manners, for example, adding the information to an address book, returning his/her own business card, searching for and following the information in social networks. One possible scenario is that the window comprises three areas, the manner corresponding module 46 makes the three areas correspond to the three information processing manners in a one-to-one manner, or makes each area respectively correspond to one or more of the three information processing manners. Certainly, it is possible that the manner corresponding module 46 makes at least one area in the window not correspond to any information processing manner. Optionally, when the information carrier overlaps with the area that does not correspond to any information processing manner, the apparatus 400 may perform no information processing on the information carried by the information carrier.

To sum up, in a scenario in which the information carried by the information carrier is different, information processing manners corresponding to the same area may also be different.

In one optional embodiment, considering that a spatial position of the information carrier or the window may change, for example, the information carrier may overlap with different areas in a process in which the user holds and moves the information carrier, in order to avoid incorrect operations, optionally, the overlapping determining module 42 is specifically configured to determine that an information carrier always overlaps with at least one area in the at least one area within a preset time period.

The preset time period may be set by the user, for example, set to 2 seconds. In some scenarios, even if the spatial position of the information carrier changes, the area that overlaps with the information carrier may not change. For example, if the range of an area that overlaps with the information carrier is large, even if the spatial position of the information carrier changes, the processing module 43 can process the information carried by the information carrier according to the information processing manner corresponding to the area as long as the overlapping determining module 42 determines that the information carrier always overlaps with the area within the preset time period.

In one optional embodiment, the processing module 43 is specifically configured to perform any one of the following processing on the information carried by the information carrier:

collecting the information;

collecting the information, and analyzing and storing the information; and

collecting the information, and analyzing and responding to the information.

Specifically, each processing may correspond to one or more information processing manners. For example, collecting the information is one information processing manner, and analyzing and storing the information is another information processing manner; or, collecting the information is one information processing manner, and collecting the information and analyzing and storing the information is another information processing manner.

For example, the window displayed by the display module 41 comprises three areas A to C, an information processing manner corresponding to the area A is collecting the information, an information processing manner corresponding to the area B is analyzing and storing the information, and an information processing manner corresponding to the area C is analyzing and responding to the information; therefore, as shown in FIG. 2a, the overlapping determining module 42 determines that the information carrier merely overlaps with the area A, and the processing module 43 collects the information, or, as shown in FIG. 2b, the overlapping determining module 42 determines that the information carrier overlaps with the areas A and B, and the processing module 43 collects the information and analyzes and stores the information, or, as shown in FIG. 2c, the overlapping determining module 42 determines that the information carrier overlaps with the areas A and C, and the processing module 43 collects the information and analyzes and responds to the information.

For another example, the window displayed by the display module 41 comprises three areas A to C, an information processing manner corresponding to the area A is collecting the information, an information processing manner corresponding to the area B is collecting the information and analyzing and storing the information, and an information processing manner corresponding to the area C is collecting the information and analyzing and responding to the information; therefore, as shown in FIG. 2a, the overlapping determining module 42 determines that the information carrier merely overlaps with the area A, and the processing module 43 collects the information, or, as shown in FIG. 2d, the overlapping determining module 42 determines that the information carrier merely overlaps with the area B, and the processing module 43 collects the information and analyzes and stores the information, or, as shown in FIG. 2e, the overlapping determining module 42 determines that the information carrier merely overlaps with the area C, and the processing module 43 collects the information and analyzes and responds to the information.

In one possible scenario, the information carrier is a business card; and the processing module 43 is specifically configured to perform any one of the following processing on the information carried by the information carrier:

collecting an image of the business card;

collecting an image of the business card, and identifying and storing the image;

collecting an image of the business card, identifying and storing the image, and sending information according to an identified communication identifier; and

collecting an image of the business card, identifying and storing the image, and performing a social operation according to an identified user identifier.

Specifically, each processing may correspond to one or more information processing manners. For example, collecting an image of the business card is one information processing manner, and identifying and storing the image is another information processing manner; or, collecting an image of the business card is one information processing manner, and collecting an image of the business card and identifying and storing the image is another information processing manner.

That the processing module 43 identifies the image may be identifying information carried by the business card; the storing may be that the processing module 43 adds the information carried by the business card to an address book; the communication identifier may be a mobile phone number, an e-mail address or the like, and accordingly, that the processing module 43 sends information according to an identified communication identifier may be sending information to the mobile phone number through a short message service message or a multimedia messaging service message, or sending information to the e-mail address in a form of an e-mail, and the information may specifically be a business card or the like of the user; the user identifier may be a name, a social network user name or the like, and accordingly, that the processing module 43 performs a social operation according to an identified user identifier may be searching for the name or the social network user name in a social network, and following a searched user or adding a searched user as a friend or the like.

It should be noted that, in the example embodiment of prompting the information processing manner, the display module 41 or the prompting module may prompt brief introduction of the information processing manner or a corresponding user category. For example, for the information processing manner of “collecting an image of the business card”, the display module 41 or the prompting module may prompt “photograph”, and for the information processing manner of “collecting an image of the business card, and identifying and storing the image”, the display module 41 or the prompting module may prompt “add to an address book”. For another example, for the information processing manner of “collecting an image of the business card, and identifying and storing the image”, the display module 41 or the prompting module may prompt “persons I may contact”; for the information processing manner of “collecting an image of the business card, identifying and storing the image, and sending information according to an identified communication identifier”, the display module 41 or the prompting module may prompt “persons I want to know”; and for “collecting an image of the business card, identifying and storing the image, and performing a social operation according to an identified user identifier”, the display module 41 or the prompting module may prompt “persons with similar interests”. The prompts are equivalent to classifications of the business card by the user, which facilitates rapid classification of business cards in social occasions and avoids delaying important dialogues or missing important information that is caused by the fact that the business cards are organized afterwards.

As shown in FIG. 3, the information carrier is a business card, a two-dimensional coordinate is shown in the window, X and Y axes of the two-dimensional coordinate divide the window into four areas. To facilitate description, an area in which both x and y are greater than 0 are referred to as a first area, an area in which y is greater than 0 and x is less than 0 is referred to as a second area, an area in which both x and y are less than 0 is referred to as a third area, and an area in which x is greater than 0 and y is less than 0 is referred to as a fourth area. The display module 41 respectively prompts corresponding information processing manners in the four areas, wherein “add to an address book, send a business card with a direct-dial phone number” is displayed in the first area, “add to an address book, send a business card with an e-mail address” is displayed in the second area, “add to an address book, add as a friend in WeChat” is displayed in the third area, and “perform no information processing” is displayed in the fourth area. When the user wants to select the information processing manner corresponding to the first area according to the prompt, the business card is moved to overlap with the first area (as shown in FIG. 3) and stays for a preset time period, and accordingly, the overlapping determining module 42 determines that the business card overlaps with the first area, and the processing module 43 performs the information processing manner corresponding to the first area on the information carried by the business card; specifically, the processing module 43 collects an image of the business card, identifies the image, adds identified information, comprising Zhang San, a phone number being 123456789, and an e-mail address being abc@d.com, to an address book, and sends a business card with a direct-dial phone number of the user to 123456789 through a short message service message or a multimedia messaging service message, or sends the business card to abc@d.com in a form of an e-mail. In this scenario, the user can rapidly and conveniently select a processing manner for the business card without affecting the original activity of the user, for example, social communication with others.

Specifically, the apparatus 400 in this embodiment may be disposed in a user equipment in a manner of software, hardware, or a combination of software and hardware, or the apparatus 400 itself is a user equipment; the user equipment comprises, but is not limited to: a smart phone, smart glasses, a and smart helmet, wherein the smart glasses comprise smart frame glasses and smart contact lenses.

For example, the apparatus 400 is smart frame glasses, and the smart frame glasses may display the window through a built-in near-eye display, and determine, by using its own detection module such as a camera, that an information carrier overlaps with at least one area in the window in a direction of a sight line of the user, or, determine, by invoking an internal or external detection module, that a spatial position of an information carrier overlaps with at least one area in the window, so as to process, according to at least one information processing manner corresponding to the at least one area that the information carrier overlaps with, information carried by the information carrier. For another example, the apparatus 400 is a smart phone, and the smart phone may project the window, and determine, by invoking an external detection module such as a camera in smart glasses, that an information carrier overlaps with at least one area in the window in a direction of a sight line of the user, or determine, by invoking an internal or external detection module, that a spatial position of an information carrier overlaps with at least one area in the window, so as to process, according to at least one information processing manner corresponding to the at least one area that the information carrier overlaps with, information carried by the information carrier.

In this embodiment, a display module displays a window comprising at least one area, an overlapping determining module determines that an information carrier overlaps with at least one area in the at least one area, and a processing module processes, according to at least one information processing manner corresponding to the at least one area that the information carrier overlaps with, information carried by the information carrier, so as to provide an information processing solution, to cause that a user can quickly and conveniently select an information processing manner.

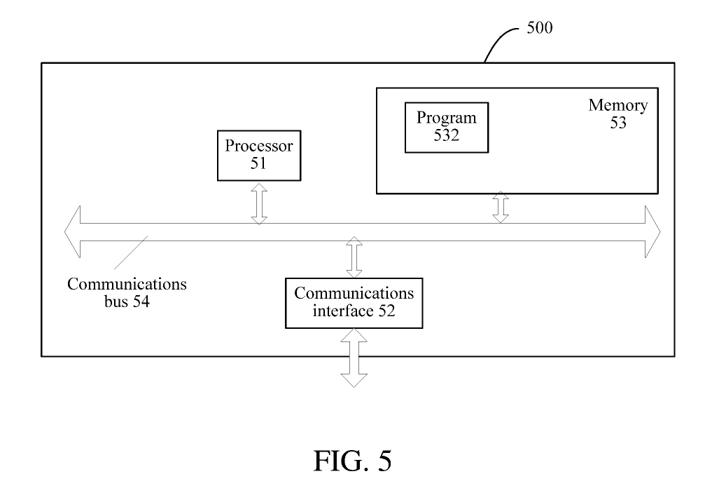

FIG. 5 is a schematic structural diagram of a second embodiment of an information processing apparatus according to the present application. As shown in FIG. 5, an information processing apparatus 500 comprises:

a processor 51, a communications interface 52, a memory 53, and a communications bus 54.

The processor 51, the communications interface 52, and the memory 53 communicate with each other by using the communications bus 54.

The communications interface 52 is configured to communicate with an external device.

The processor 51 is configured to execute a program 532, and specifically, may implement relevant steps in the embodiments of the information processing methods.

Specifically, the program 532 may comprise program code, wherein the program code comprises a computer operation instruction.

The processor 51 may be a central processing unit (CPU), or an application specific integrated circuit (ASIC), or one or more integrated circuits configured to implement the embodiments of the information processing methods.

The memory 53 is configured to store the program 532. The memory 53 may comprise a high-speed random access memory (RAM), or may also comprise a non-volatile memory, for example, at least one magnetic disk memory. The program 532 may be specifically configured to enable the information processing apparatus 500 to perform the following steps:

displaying a window, wherein the window comprises at least one area, and the at least one area respectively corresponds to one information processing manner;

determining that an information carrier overlaps with at least one area in the at least one area; and

processing, according to at least one information processing manner corresponding to the at least one area that the information carrier overlaps with, information carried by the information carrier.

For specific implementation of the steps in the program 332, reference may be made to corresponding description in the corresponding steps and units in the embodiments of the information processing methods, and no further details are provided herein again. A person skilled in the art may clearly know that, for the purpose of convenient and brief description, for a detailed working process of the foregoing device and modules, reference may be made to a corresponding process in the foregoing embodiments of the foregoing information processing methods, and no further details are provided herein again.

A person of ordinary skill in the art may be aware that, with reference to the examples described in the embodiments disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

When the functions are implemented in a form of a software functional unit and sold or used as an independent product, the functions may be stored in a computer-readable storage medium. Based on such an understanding, the technical solutions of the present application essentially, or the part contributing to the prior art, or a part of the technical solutions may be implemented in a form of a software product. The computer software product is stored in a storage medium, and comprises several instructions for instructing a computer device (which may be a personal computer, a server, a network device, or the like) to perform all or a part of the steps of the methods described in the embodiments of the present application. The foregoing storage medium comprises: any medium that can store program code, such as a USB flash drive, a removable hard disk, a read-only memory (ROM, Read-Only Memory), a RAM, a magnetic disk, or an optical disc.

The foregoing example embodiments are merely used for describing the present embodiments, rather than limiting the present application. A person of ordinary skill in the art may made various changes and modifications without departing from the spirit and scope of the present embodiments, and therefore, all equivalent technical solutions shall belong to the scope of the present embodiments, and the protection scope of the present embodiments shall be subject to the claims.

What is claimed is:

1. A method, comprising:
displaying, by a system comprising a processor, a window, wherein the window comprises at least one area, and the at least one area respectively corresponds to one information process;
determining that an information carrier overlaps with an area in the at least one area; and
processing, according to at least one information process corresponding to the area with which the information carrier overlaps, information carried by the information carrier.

2. The method of claim 1, wherein the displaying the window comprises:
acquiring a gaze point of a user; and
displaying the window at the gaze point.

3. The method of claim 1, wherein the displaying the window comprises:
displaying the window at a position with a preset distance in front of at least one eye of a user.

4. The method of claim 1, wherein a corresponding information process is respectively displayed in the at least one area.

5. The method of claim 1, wherein, before the processing, according to at least one information process corresponding to the area with which the information carrier overlaps, the information carried by the information carrier, the method further comprises:
determining the information carried by the information carrier;
determining at least one information process corresponding to the information; and
determining a correspondence between the at least one information process corresponding to the information and the at least one area comprised in the window.

6. The method of claim 1, wherein the processing, according to at least one information process corresponding to the area with which the information carrier overlaps, the information carried by the information carrier comprises at least one of:
collecting the information;
collecting the information, and analyzing and storing the information; and
collecting the information, and analyzing and responding to the information.

7. The method of claim 1, wherein the determining that the information carrier overlaps with the area in the at least one area comprises:
determining that the information carrier always overlaps with the area in the at least one area within a preset time period.

8. The method of claim 1, wherein the information carrier comprises at least one of a business card, a picture, a label, a two-dimensional code, or a terminal interface.

9. The method of claim 8, wherein the information carrier is the business card; and the processing, according to the at least one information process corresponding to the area with which the information carrier overlaps, the information carried by the information carrier comprises at least one of:
collecting an image of the business card;
collecting the image of the business card, and identifying and storing the image;
collecting the image of the business card, identifying and storing the image, and sending information according to an identified communication identifier; and
collecting the image of the business card, identifying and storing the image, and performing a social operation according to an identified user identifier.

10. An apparatus, comprising:
a memory that stores executable modules; and
a processor, coupled to the memory, that executes or facilitates execution of the executable modules, comprising:
a display module configured to display a window, wherein the window comprises at least one area, and the at least one area respectively corresponds to one information process;
an overlapping determining module configured to determine that an information carrier overlaps with at least one of the at least one area; and
a processing module configured to process, according to at least one information process corresponding to the at least one of the at least one area with which the information carrier overlaps, information carried by the information carrier.

11. The apparatus of claim 10, wherein the display module is further configured to:
acquire a gaze point of a user identity; and
display the window at the gaze point.

12. The apparatus of claim 10, wherein the display module is further configured to:
display the window at a position with a preset distance in front of at least one eye of a user identity.

13. The apparatus of claim 10, wherein the display module is further configured to respectively display one corresponding information process in the at least one area.

14. The apparatus of claim 10, wherein the executable modules further comprises:
an information determining module configured to determine the information carried by the information carrier;
a manner determining module configured to determine at least one information process corresponding to the information; and
a manner corresponding module configured to determine a correspondence between the at least one information process corresponding to the information and the at least one area comprised in the window.

15. The apparatus of claim 10, wherein the processing module is further configured to perform, on the information carried by the information carrier, any one of:
collecting the information;
collecting the information, and analyzing and storing the information; and
collecting the information, and analyzing and responding to the information.

16. The apparatus of claim 10, wherein the overlapping determining module is further configured to:
determine that the information carrier always overlaps with the at least one of the at least one area within a preset time period.

17. The apparatus of claim 10, wherein the information carrier comprises any one of a business card, a picture, a label, a two-dimensional code, or a terminal interface.

18. The apparatus of claim 17, wherein the information carrier is the business card; and the processing module is further configured to perform, on the information carried by the information carrier, any one of:
collecting an image of the business card;
collecting the image of the business card, and identifying and storing the image;
collecting the image of the business card, identifying and storing the image, and sending information according to an identified communication identifier; and
collecting the image of the business card, identifying and storing the image, and performing a social operation according to an identified user identifier.

19. A computer readable storage device comprising executable instructions that, in response to execution, cause a device comprising a processor to perform operations, comprising:
displaying a window, wherein the window comprises a set of areas, and the set of areas respectively correspond to an information process;
determining that an information carrier overlaps with at least one area in the set of areas; and
processing, according to at least one information process corresponding to the at least one area with which the information carrier overlaps, information carried by the information carrier.

20. The computer readable storage device of claim 19, wherein the displaying the window comprises:
acquiring a gaze point associated with a user identity; and
displaying the window at the gaze point.
